(19) United States
(12) Patent Application Publication
(10) Pub. No.: US 2026/0241686 A1
(43) Pub. Date: Aug. 20, 2026

(54) IMAGE FORMING APPARATUS THAT VARIES DIAMETER OF INK DROPLET EJECTED FROM NOZZLE

(71) Applicant: KYOCERA Document Solutions Inc., Osaka (JP)

(72) Inventor: Masaru MASUKO, Osaka (JP)

(73) Assignee: KYOCERA Document Solutions Inc., Osaka (JP)

(21) Appl. No.: 19/541,273

(22) Filed: Feb. 16, 2026

(30) Foreign Application Priority Data
Feb. 18, 2025 (JP) 2025-024584

(51) Int. Cl. B41J 2/045

(52) U.S. Cl. CPC B41J 2/04593; B41J 2/04581; B41J 2/04588

(57) ABSTRACT

An image forming apparatus includes a controller that controls a drive waveform for varying an ink droplet diameter, when ejecting an ink droplet from a nozzle onto a solid portion in an image to be printed. Along a main scanning direction, the controller alternately uses an M waveform for ejecting the ink droplet of M size, and an LL waveform for ejecting the ink droplet of LL size, originally supposed to be used for non-ejection correction, for one of even-numbered rows and odd-numbered rows, and uses only a 0 (zero) waveform that restricts the ink droplet from being ejected, for the other of the rows. In a column direction along a sub scanning direction, the controller alternately uses the M waveform and the LL waveform, in a cycle of either of the even-numbered rows and the odd-numbered rows.

### INCORPORATION BY REFERENCE

This application claims priority to Japanese Patent Application No. 2025-024584 filed on February 18, 2025, the entire contents of which are incorporated by reference herein.

### BACKGROUND

The present disclosure relates to an inkjet image forming apparatus.

The inkjet image forming apparatus includes an ink head that varies the diameter of an ink droplet ejected from a nozzle (ink dot diameter), according to the type of a drive waveform applied to the ink head, and controls the ink droplet diameter using the drive waveform, thereby expressing the gradation of the print image.

### SUMMARY

The disclosure proposes further improvement of the foregoing technique.

In an aspect, the disclosure provides an image forming apparatus including an ink head and a control device. The ink head includes a plurality of nozzles that each eject an ink droplet onto a recording medium, the nozzles being aligned along a main scanning direction, and varies a diameter of the ink droplet ejected from the nozzle, according to a type of a drive waveform applied to the nozzle. The control device includes a processor, and acts as a controller when the processor executes a control program. The controller controls the drive waveform to be applied to the ink head. The image forming apparatus is based on an inkjet system in which a printing resolution in a sub scanning direction is twice as high as a printing resolution in the main scanning direction. The controller employs four types of the drive waveform, which are a first waveform for ejecting the ink in a predetermined first droplet diameter for predetermined normal printing, a second waveform for ejecting the ink in a predetermined second droplet diameter, of a predetermined first size larger than the first droplet diameter, for the normal printing, a third waveform for ejecting the ink in a predetermined third droplet diameter, of a predetermined second size larger than the second droplet diameter, and a 0th waveform that restricts the ink droplet from being ejected. The controller controls, when ejecting the ink to form an image of a solid portion in an image to be printed, the drive waveform for ejecting the ink droplet from the nozzle, by using, for a row direction along the main scanning direction, the second waveform and the third waveform alternately, for either of even-numbered rows and odd-numbered rows, and using only the 0th waveform or the first waveform, for the other of the rows.

### BRIEF DESCRIPTION OF THE DRAWINGS

FIG. 1 is a functional block diagram schematically showing an essential internal configuration of an image forming apparatus according to a first embodiment of the disclosure;

FIG. 2A and FIG. 2B are schematic drawings for explaining a control process of ink droplet diameter, for a solid portion in an image to be printed;

FIG. 3 is a flowchart showing an example of a control process performed by a controller, to control drive waveform for ejecting ink, when forming an image from a read image acquired by an image reading device;

FIG. 4 is a schematic diagram showing exemplary ink ejection index values for each pixel, with respect to raster data of an image including a solid portion;

FIG. 5A and FIG. 5B are schematic diagrams each showing an example of a pattern to be used to identify a region to perform a substitution process;

FIG. 6 is a schematic diagram for explaining the region to perform the substitution process;

FIG. 7 is a schematic diagram showing an example of an image processing filter;

FIG. 8 is a schematic diagram showing an example of the raster data after the substitution process;

FIG. 9A and FIG. 9B are schematic drawings for explaining the control process of ink droplet diameter, for the solid portion in the image to be printed;

FIG. 10A to FIG. 10C are schematic diagrams each showing an example of arrangement of ink droplets for a solid portion in the image to be printed, based on a common technique; and

FIG. 11A and FIG. 11B are schematic diagrams for explaining a non-ejection correction process according to a common technique.

### DETAILED DESCRIPTION

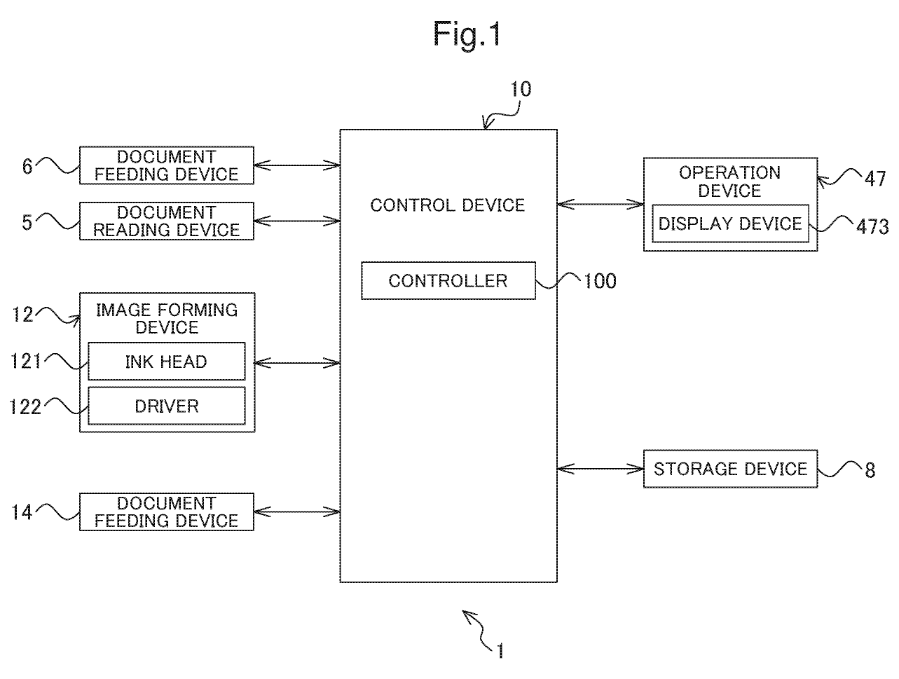

FIG. 1 is a functional block diagram schematically showing an essential internal configuration of an image forming apparatus according to a first embodiment of the disclosure. The image forming apparatus 1 is a multifunction peripheral having a plurality of functions, such as copying, printing, scanning, and facsimile transmission.

The image forming apparatus 1 includes a control device 10, a document feeding device 6, a document reading device 5, an image forming device 12, a sheet feeding device 14, an operation device 47, and a storage device 8.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6, generally called an automatic document feeder (ADF), includes a non-illustrated document tray, and feeds the documents placed on the document tray to the document reading device 5.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

To perform the image forming operation, the image forming apparatus 1 operates as follows. The image forming device 12 includes ink heads 121 that eject ink droplets of four colors (cyan, magenta, yellow, and black) onto a recording medium, to form an image thereon, drivers 122 that cause the respective ink heads 121 to eject the ink, and a non-illustrated printing conveying device and drying conveying device. The ink head 121 includes a plurality of nozzles that each eject the ink droplets onto the recording medium, the nozzles being aligned along the main scanning direction, and varies the diameter of the ink droplet ejected from the nozzle, according to the type of the drive waveform applied to the ink head 121. For example, a piezoelectric element provided for each nozzle is deformed by the signal of the drive waveform, and the ink of an amount corresponding to the deformation is ejected from the nozzle.

The printing resolution of the image forming device 12 in the sub scanning direction is twice as high as the printing resolution in the main scanning direction. For example, when the printing resolution in the main scanning direction is 600 dpi (or 1200 dpi), the printing resolution in the sub scanning direction is 1200 dpi (or 2400 dpi).

The image forming device 12 forms an image by ink jet printing using the ink which is the recording material, on a recording sheet, exemplifying the recording medium, delivered from the sheet feeding device 14, on the basis of the image data generated through the document reading operation, image data stored in the image memory, or image data received from a computer connected via the network.

The printing conveying device includes an endless conveying belt, and conveys the recording sheet placed on the conveying belt, and opposed to the ink heads 121. The drying conveying device also includes, like the printing conveying device, an endless conveying belt, and conveys the recording sheet having an image formed thereon and placed on the conveying belt, to naturally dry the ink stuck to the recording sheet.

The sheet feeding device 14 includes a sheet cassette 141, and also includes a pickup roller, transport rollers, a transport route, and rotational drive mechanism for the rollers, to pick up the recording sheet from the sheet cassette 141 and transport the recording sheet to the image forming device 12.

The operation device 47 includes various hard keys to be operated by the user, and receives the user’s instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user’s instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The storage device 8 is a large-capacity storage device such as a hard disk drive (HDD) or a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes a controller 100.

To be more specific, the control device 10 acts as the controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the sheet feeding device 14, the operation device 47, and the storage device 8, and controls the operation of the mentioned components. The controller 100 also executes some processings required for the image forming operation to be performed by the image forming apparatus 1.

For example, the controller 100 controls the operation of the driver 122, thereby controlling the drive waveform to be applied to the ink head 121, on the basis of the data representing the image to be printed. The controller 100 controls the operation of the image forming device 12 so as to perform normal printing and non-ejection correction. The normal printing refers to a printing operation including ejecting the ink from the nozzle on the basis of the data of the image to be printed, thereby forming an image. The non-ejection correction refers to an operation including ejecting, when any of the nozzles has failed to normally eject the ink, a larger amount of ink having a third droplet diameter (LL size), to be subsequently described, from a nozzle in the proximity of the non-ejecting nozzle, to make up the ink amount corresponding to the amount of the ink that was originally supposed to be ejected from the non-ejecting nozzle, thereby securing the ink amount required per unit area.

The controller 100 employs, as the drive waveform, a first waveform W1 (S waveform) for ejecting the ink in a predetermined first droplet diameter (S size) for the normal printing, a second waveform W2 (M waveform) for ejecting the ink in a second droplet diameter (M size), of a predetermined size larger than the first droplet diameter, for the normal printing, a third waveform W3 (LL waveform) for ejecting the ink in a third droplet diameter (LL size), of a predetermined size larger than the second droplet diameter, which is originally supposed to be used for the non-ejection correction, and a 0th waveform W0 (0 waveform) that restricts the ink droplet from being ejected. The information regarding these waveforms is stored in the storage device 8.

In this embodiment, in the printing operation of the image to be printed by normal printing, the controller 100 controls the driver 122 using the first waveform W1 (S waveform) and the second waveform W2 (M waveform), for the portion of the image other than a solid portion.

With respect to the solid portion in the image to be printed, in the printing operation of the image to be printed by normal printing, the controller 100 controls the drive waveform for ejecting the ink droplet from the nozzle, by using, for a row direction along the main scanning direction, the second waveform W2 (M waveform) and the third waveform W3 (LL waveform) alternately, for either of even-numbered rows and odd-numbered rows, and using only the 0th waveform W0 (0 waveform), for the other of the rows. Further, when causing the image forming device 12 to form the image of the solid portion, the controller 100 controls, by controlling the operation of the driver 122, the drive waveform to be applied to the ink head 121, so as to alternately use the second waveform W2 (M waveform) and the third waveform W3 (LL waveform), for the nozzles aligned in the column direction along the sub scanning direction, in the cycle of either of the even-numbered rows and the odd-numbered rows. Here, the solid portion refers to a portion completely covered with the ink, without gradation or reverse-out portion.

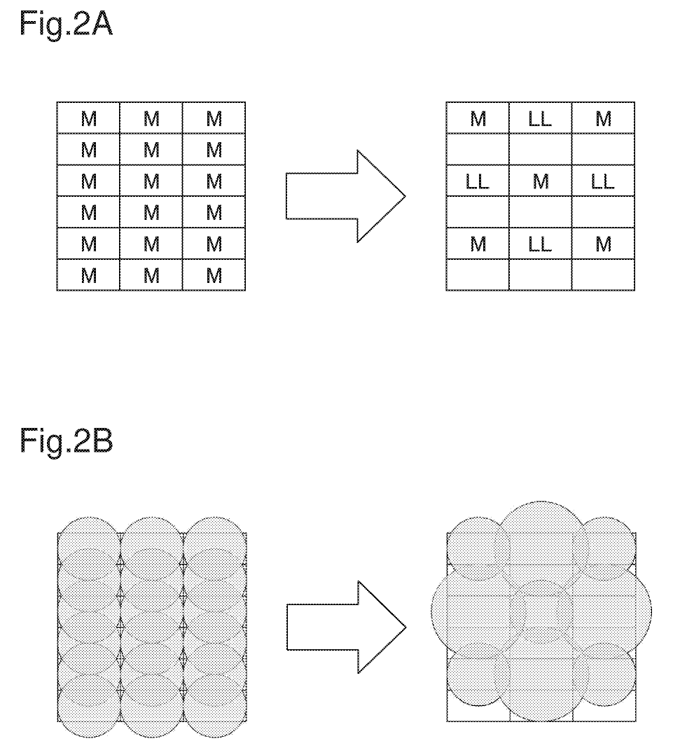

In the case where the drive waveform is not controlled as above, for the solid portion in the image, the same waveform, for example the second waveform W2 (M waveform) is used for all the nozzles corresponding to the solid portion, and the ink of the second droplet diameter (M size) is ejected from all the nozzles to the pixel, as shown in the left-side part of FIG. 2A and FIG. 2B. In contrast, when the drive waveform is controlled according to this embodiment, for the solid portion in the image, the ink of the second droplet diameter (M size) and the ink of the third droplet diameter (LL size) are alternately ejected along the main scanning direction (left-right direction in the drawings), and ejection in the second droplet diameter (M size), non-ejection, ejection in the third droplet diameter (LL size), and non-ejection are sequentially repeated along the sub scanning direction, as shown in the right-side part of FIG. 2A and FIG. 2B.

Thus, for printing the solid portion in the image by normal printing, the controller 100 adopts the ejection of the ink using a plurality of waveforms, namely the second waveform W2, the third waveform W3, and the 0th waveform W0, instead of the ejection of the ink with a single drive waveform from all the nozzles, and adopts the combination of the M size, the LL size, and the 0 size, for the ink droplets for printing the solid portion in the image.

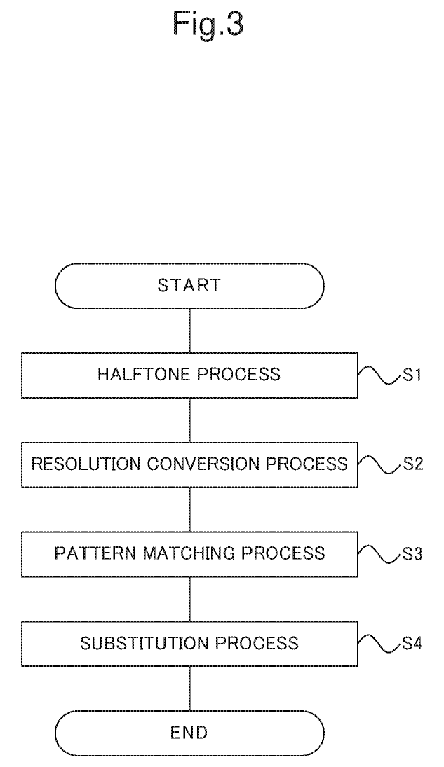

Referring to a flowchart shown in FIG. 3, an example of the control process of the drive waveform for ejecting the ink, performed by the controller 100 when forming the image based on the read image acquired by the image reading device 5, will be described hereunder. For the description given hereunder, it will be assumed that the reading resolution of the image reading device 5 is 1200 dpi in both of the main scanning direction and the sub scanning direction, and that the printing resolution of the image forming device 12 is 1200 dpi in the sub scanning direction, and 600 dpi in the main scanning direction, which is a half of the resolution in the sub scanning direction.

The controller 100 performs a halftone process, with respect to the read image data acquired by the image reading device 5 (S1), and converts the resolution of the read image data, turned to raster data through the halftone process, to a half along the main scanning direction (S2). By reducing thus the number of pixels, along the main scanning direction of the read image data, to a half, the controller 100 adjusts the resolution of the read image to 600 dpi, which is the printing resolution. More specifically, the controller 100 deletes one of two pixels adjacent to each other in the main scanning direction, leaving the other one.

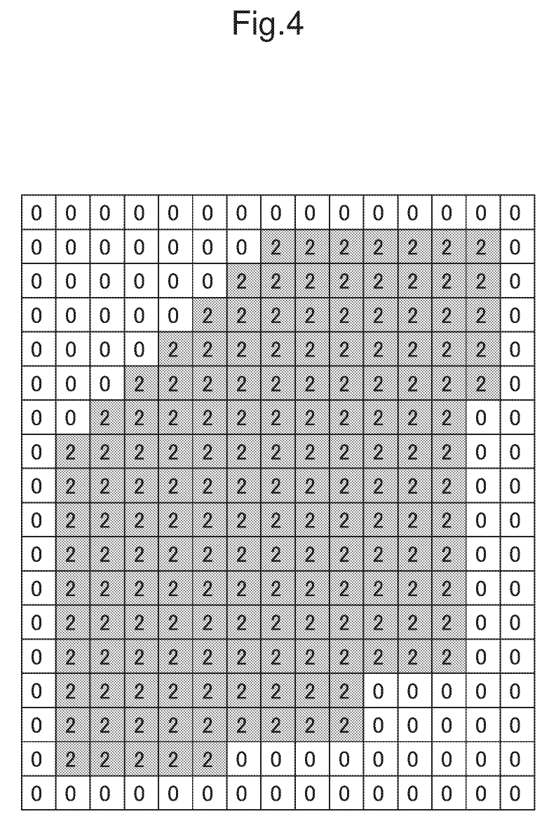

In such resolution conversion process, the controller 100 further adds the pixel value of the deleted pixel to the pixel value of the remaining pixel, with respect to the pixel value of the two pixels adjacent to each other. When the total pixel value of the two pixels adjacent to each other is still “0”, the controller 100 sets the ink ejection index value for the remaining pixel to “0”. When the total pixel value of the two pixels adjacent to each other is equal to the pixel value of one of those two pixels, the controller 100 sets the ink ejection index value to “1”. Further, when the total pixel value of the two pixels adjacent to each other corresponds to the sum of the pixel values of the respective pixels, and is larger than the pixel value of one of those two pixels, the controller 100 sets the ink ejection index value to “2”. Accordingly, the ink ejection index value of one pixel after the conversion assumes one of three values, “0”, “1”, or “2”. FIG. 4 illustrates examples of the ink ejection index value of each pixel, in the raster data of the image including the solid portion.

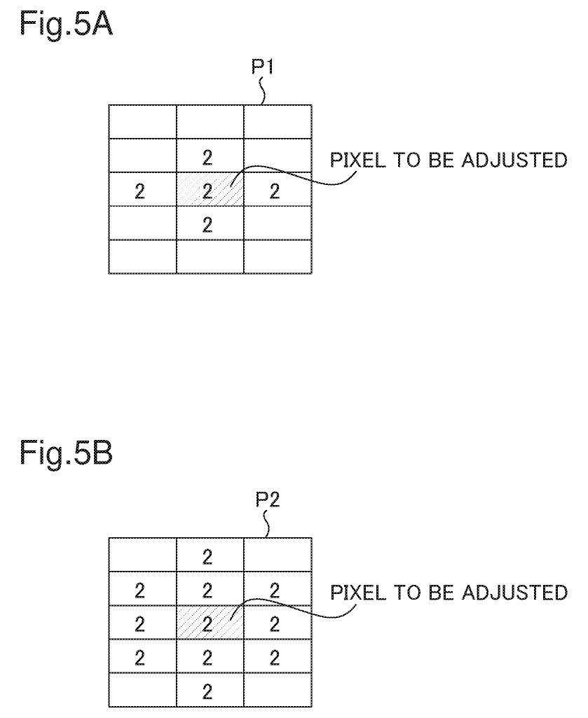

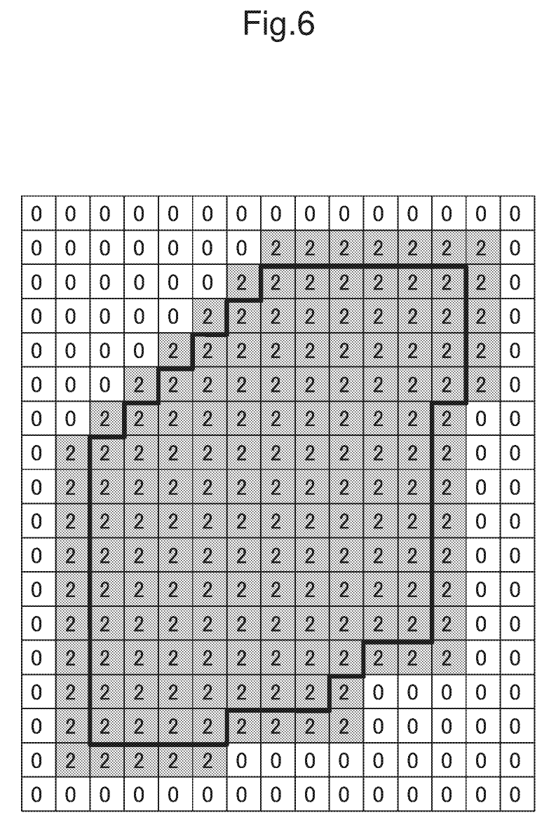

Then the controller 100 performs a pattern matching process, to distinguish between the edge of the solid portion and the inside of the edge (S3). FIG. 5A and FIG. 5B each illustrate an example of the pattern to be used to identify the region of the solid portion, to be controlled by the drive waveform. This pattern is applied to the raster data constituted of the ink ejection index values shown in FIG. 4. The pattern P1 shown in FIG. 5A indicates that, when the ink ejection index values of a focused pixel, and the adjacent pixels in four directions, namely on the left, right, upper, and lower sides, are all “2”, the focused pixel is the object to be controlled by the drive waveform. The pattern P2 shown in FIG. 5B indicates that, when the ink ejection index values of a focused pixel, and the adjacent pixels in eight directions, namely on the left, right, upper, lower, and diagonal sides, are all “2”, the focused pixel is the object to be controlled by the drive waveform. When the pattern P1 shown in FIG. 5A is adopted for the raster data shown in FIG. 4, the pixels in the region surrounded by bold lines in FIG. 6 become the objects to be controlled by the drive waveform.

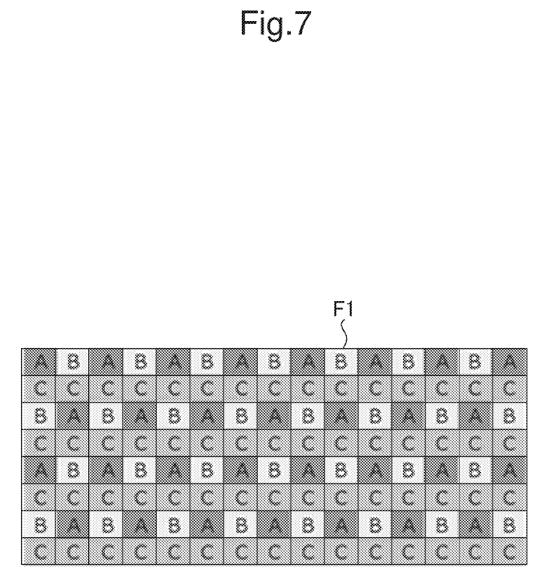

The controller 100 substitutes the drive waveform to be used for the solid portion in the image to be formed, with one of the second waveform W2, the third waveform W3, and the 0th waveform W0, using an image processing filter F1 in which three phases (A-phase, B-phase, and C-phase) are set as shown in FIG. 7 (S4). Thereafter, the operation specified in FIG. 3 is finished.

As shown in FIG. 7, three phases, namely the A-phase, the B-phase, and the C-phase are set in the image processing filter F1. The controller 100 substitutes the drive waveform of the A-phase with the second waveform W2 (M waveform), the drive waveform of the B-phase with the third waveform (LL waveform), and the drive waveform of the C-phase with the 0th waveform (0 waveform).

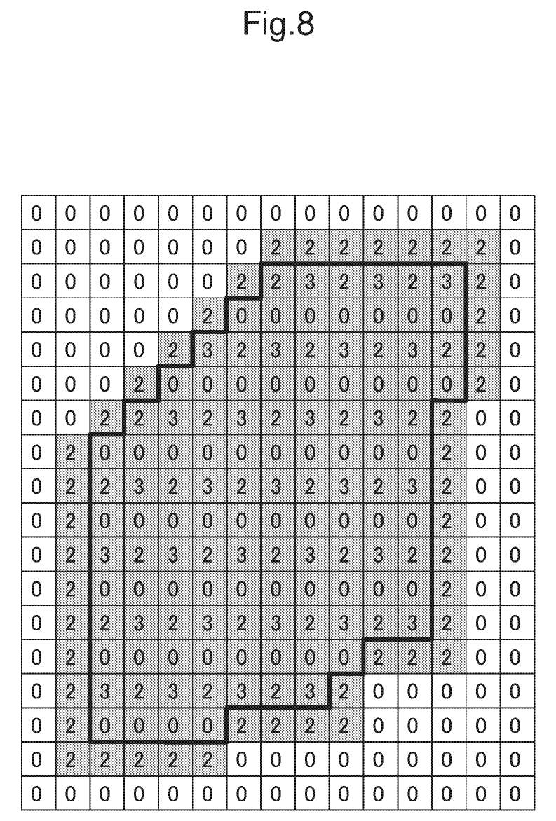

In other words, the A-phase is substituted with the M size, corresponding to the ink ejection index value of “2”, the B-phase is substituted with the LL size, corresponding to the ink ejection index value of “3”, and the C-phase is substituted with the 0 size, corresponding to the ink ejection index value of “0”. As a result, the raster data shown in FIG. 4 is converted into the raster data composed of the ink ejection index values shown in FIG. 8.

Thereafter, the controller 100 causes the image forming device 12 to eject the ink, onto the solid portion in the image to be printed by normal printing, using the drive waveform indicated by the raster data that has been converted as above.

According to the first embodiment, combining the second droplet diameter (M size, pixel value “2”) for the normal printing, the third droplet diameter (LL size, pixel value “3”), originally supposed to be used for the non-ejection correction, and the 0th waveform (0 size, pixel value “0”) that restricts the ink droplet from being ejected, for the solid portion in the image to be printed by normal printing, contributes to reducing the amount of the ink used for the solid portion, to an appropriate amount. In addition, there is no need to use the ink droplet diameter of an L size, to be subsequently referred to as a common technique, and only four types of the drive waveform are employed. Therefore, the amount of the ink used for the solid portion in the image to be printed can be reduced to an appropriate amount, and also the number of bits required for storing the types of the drive waveform can be reduced, which leads to reduced data amount necessary for the image processing. As result, high picture quality (e.g., reduced streaks) and reduction in hardware resource can both be achieved.

In addition, by performing the pattern matching using the pattern P1 shown in FIG. 5A, the pixel adjacently surrounded by four pixels, on the left, right, upper, and lower sides, which all have the pixel value of “2”, becomes the object to be controlled. Accordingly, the pixel constituting the edge of the solid portion is excluded from the objects to be controlled by the drive waveform. Therefore, the image of the edge is prevented from being printed with the ink ejection controlled by the drive waveform, and the contour of the solid portion can be prevented from collapsing, so that the image corresponding to the edge can be protected.

Here, although the first embodiment refers to the case where the pattern matching is performed using the pattern P1 shown in FIG. 5A, the controller 100 may perform the pattern matching using the pattern P2 shown in FIG. 5B. In this case, the pixel adjacently surrounded by eight pixels, on the left, right, upper, lower, and diagonal sides, which all have the pixel value of “2”, becomes the object to be controlled by the drive waveform, which further assures that the image corresponding to the edge can be protected.

Further, as a second embodiment, the controller 100 may control the drive waveform, so as to use the first waveform W1 (S waveform), instead of the 0th waveform W0 (0 waveform), for the solid portion in the image to be printed, indicated by the data thereof.

To be more specific, the controller 100 substitutes the drive waveform to be used for the solid portion with one of the second waveform W2, the third waveform W3, and the first waveform W1, thereby adopting the combination of the M size, the LL size, and the S size, as the ink droplet for the solid portion.

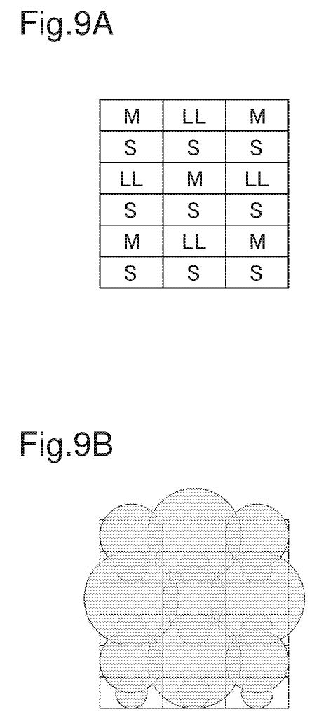

By controlling the drive waveform as above for the solid portion, the ink of the second droplet diameter (M size) and the ink of the third droplet diameter (LL size) alternately appear along the main scanning direction (left-right direction in the drawings), and the ink of the second droplet diameter (M size), the ink of the first droplet diameter (S size), the ink of the third droplet diameter (LL size), and the ink of the first droplet diameter (S size) sequentially appear along the sub scanning direction, as shown in FIG. 9A and FIG. 9B.

In the case of a predetermined type of recording sheet, such as a specialized inkjet paper, which does not absorb the ink as a plain paper does, it is preferable to adopt the arrangement according to the second embodiment, because in this case the ink ejection amount is larger, compared with the first embodiment. In the case of the plain paper, on the contrary, it is preferable to adopt the arrangement according to the first embodiment, because the ink ejection amount is smaller, compared with the second embodiment. Thus, the optimum ink ejection can be realized, according to the type of the recording medium. The controller 100 may switch the control mode of the drive waveform, between the controls according to the first embodiment and the second embodiment, depending on the type of the recording medium indicated by the instruction inputted to the operation device 47. For example, when the recording medium, indicated by the instruction inputted to the operation device 47, is of the predetermined type, the controller 100 executes the drive waveform control according to the second embodiment, but executes the drive waveform control according to the first embodiment, when the recording medium, indicated by the instruction inputted to the operation device 47, is the plain paper.

Some of the existing image forming apparatuses, not configured according to the foregoing embodiments, set the printing resolution in the sub scanning direction, for example, to be twice as high as the printing resolution in the main scanning direction (set the ratio of the printing resolution in the main scanning direction and the printing resolution in the sub scanning direction to 1:2), to realize high-resolution printing. For example, in the case of the ink head of 600 dpi, the resolution in the sub scanning direction is set to 1200 dpi, and for the ink head of 1200 dpi, the resolution in the sub scanning direction is set to 2400 dpi, to attain higher resolution.

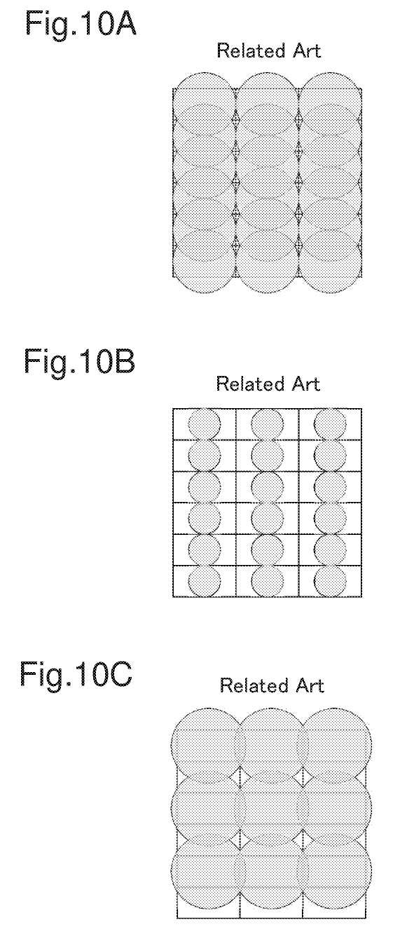

Hereunder, the image forming of the solid portion in the image to be printed will be described, regarding the case where the ink is ejected from the nozzle onto the pixel, under the mentioned setting of the resolution adopted in the existing image forming apparatuses, not configured according to the foregoing embodiments. Referring to FIG. 10A, when the ink droplet diameter is set so as to fit the main scanning direction (left-right direction in the drawing), with the solid portion unchanged from the original data, although the main scanning direction can be fully covered with the ink, an excessive amount of ink droplets are applied (overflow) along the sub scanning direction (up-down direction in the drawing), since the printing interval is a half of that in the main scanning direction. Therefore, an excessive amount of ink is provided onto the recording sheet. On the other hand, when the ink droplet diameter is set so as to fit the sub scanning direction, although the overflow can be avoided, the ink fails to be connected in the main scanning direction, and streaks are produced, as shown in FIG. 10B.

Accordingly, as shown in FIG. 10C, the ink may be ejected to the solid portion in an ink droplet diameter larger than that of the normal printing, and the printing along the sub scanning direction may be performed in an interval according to the resolution along the main scanning direction. Here, the ink droplet diameter shown in FIG. 10A is herein referred to as “M size”, the ink droplet diameter shown in FIG. 10B, smaller than that of FIG. 10A is herein referred to as “S size”, and the ink droplet diameter shown in FIG. 10C is herein referred to as “L size”, since this is larger than both of the above.

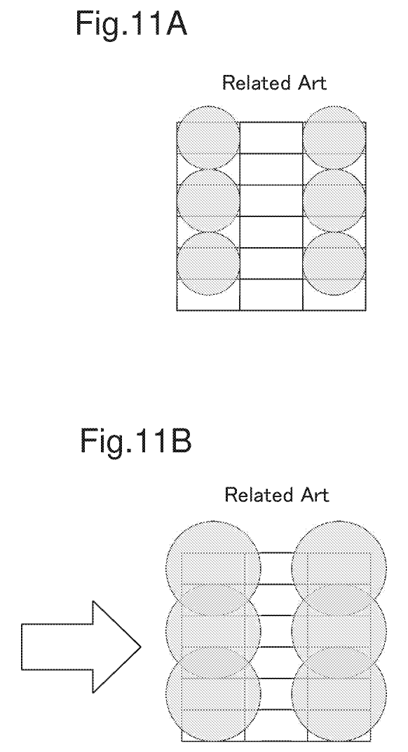

Such existing inkjet image forming apparatus may perform the non-ejection correction. The non-ejection correction is performed when any of the nozzles has failed to normally eject the ink, and includes additionally ejecting, from a nozzle in the proximity of the non-ejecting nozzle, the ink of an amount originally supposed to be ejected from the non-ejecting nozzle, thereby securing the ink amount required per unit area, and preventing degradation in picture quality, such as appearance of streaks. For example, when the nozzle at the center fails to normally eject the ink as shown in FIG. 11A, the ink droplet diameter of the ink ejected from the nozzles on the respective sides is increased, to increase the amount of the ejected ink, as shown in FIG. 11B. The ink droplet diameter shown in FIG. 11B is herein referred to as “LL size”, because this is larger than the ink droplet diameter shown in FIG. 10C.

Ejecting thus the ink droplets of totally five sizes, namely the S, M, L, and LL sizes, and also the 0 (zero) size corresponding to non-ejection, onto the solid portion in the image to be printed by normal printing, enables the amount of the ink to be ejected to form the image of the solid portion to be maintained at an appropriate level. However, to set all the five types of ink droplet diameter in the image forming apparatus, five types of drive waveform are necessary. In the case where four or fewer types of drive waveform are employed, the drive waveform can be distinguished from each other by 2 bits (00, 01, 10, 11), and therefore a bit width of 2 bits is sufficient for controlling the ink droplet diameter per pixel. On the other hand, when five types of drive waveform are employed, a bit width of 3 bits becomes necessary, to control the ink droplet diameter per pixel. In other words, the data amount required for the image processing is increased to 150% (= 3/2), and the circuit for image processing becomes more complicated.

With the arrangement according to the foregoing embodiments, in contrast, the image forming apparatus, in which the resolution in the sub scanning direction is set to be twice as high as the resolution in the main scanning direction, can maintain the amount of the ink, ejected to form the solid portion in the image to be printed, at an appropriate level, and also suppress the data amount required for the image processing.

The disclosure may be modified in various manners, without limitation to the foregoing embodiments. Further, the configurations and processings according to the embodiments, described with reference to FIG. 1 to FIG. 9, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

1. An image forming apparatus comprising:
an ink head including a plurality of nozzles that each eject an ink droplet onto a recording medium, the nozzles being aligned along a main scanning direction, and configured to vary a diameter of the ink droplet ejected from the nozzle, according to a type of a drive waveform applied to the ink head; and
a control device including a processor, and configured to act as a controller that controls the drive waveform to be applied to the ink head, when the processor executes a control program,
the image forming apparatus being based on an inkjet system in which a printing resolution in a sub scanning direction is twice as high as a printing resolution in the main scanning direction,
wherein the controller employs four types of the drive waveform, which are:
a first waveform for ejecting the ink in a predetermined first droplet diameter for predetermined normal printing;
a second waveform for ejecting the ink in a predetermined second droplet diameter, of a predetermined first size larger than the first droplet diameter, for the normal printing;
a third waveform for ejecting the ink in a predetermined third droplet diameter, of a predetermined second size larger than the second droplet diameter; and a 0th waveform that restricts the ink droplet from being ejected,
the controller controls, when ejecting the ink to form an image of a solid portion in an image to be printed, the drive waveform for ejecting the ink droplet from the nozzle, by using, for a row direction along the main scanning direction, the second waveform and the third waveform alternately, for one of even-numbered rows and odd- numbered rows, and using only the 0th waveform or the first waveform, for the other of the rows.

2. The image forming apparatus according to claim 1, further comprising an operation device that receives an instruction to designate a type of the recording medium,
wherein the controller is configured to:
control the drive waveform using only the first waveform for the other of the rows, in the row direction along the main scanning direction, when the type of the recording medium indicated by the instruction inputted to the operation device is a predetermined type; and
control the drive waveform using only the 0th waveform for the other of the rows, in the row direction along the main scanning direction, when the type of the recording medium indicated by the instruction inputted to the operation device is a plain paper.

3. The image forming apparatus according to claim 1,
wherein the controller controls the drive waveform, when ejecting the ink to form an image of the solid portion, by alternately using the second waveform and the third waveform, in a column direction along the sub scanning direction, in a cycle of either of the even-numbered rows and the odd-numbered rows.

4. The image forming apparatus according to claim 1,
wherein the controller identifies a region for adjusting the drive waveform, through a pattern matching process for distinguishing between an edge and a portion inside the edge, with respect to the solid portion, and controls the drive waveform with respect to the portion other than the edge of the solid portion.

5. The image forming apparatus according to claim 1,
wherein the controller controls the drive waveform to be used to form the image of the solid portion, using an image processing filter in which three types of phase are set, either by substituting with one of the second waveform, the third waveform, and the 0th waveform, or by substituting with one of the second waveform, the third waveform, and the first waveform.
